(19) United States
(12) Patent Application Publication
(10) Pub. No.: US 2025/0389859 A1
(43) Pub. Date: Dec. 25, 2025

(54) METHOD AND SYSTEM FOR SELECTING NEAR-SOURCE STRONG MOTION RECORDS CONSIDERING FLING-STEP EFFECTS

(71) Applicant: Jianghan University, Wuhan (CN)

(72) Inventors: Longjun XU, Wuhan (CN); Chaoyue JIN, Wuhan (CN); Hao TIAN, Wuhan (CN); Ji ZHANG, Wuhan (CN); Ge KONG, Wuhan (CN)

(73) Assignee: Jianghan University, Wuhan (CN)

(21) Appl. No.: 19/260,398

(22) Filed: Jul. 4, 2025

(30) Foreign Application Priority Data
Jan. 13, 2025 (CN) 202510050704.8

(51) Int. Cl. G01V 1/28; G01V 1/01; G01V 1/30

(52) U.S. Cl. CPC G01V 1/282; G01V 1/01; G01V 1/30

(57) ABSTRACT

A method for selecting near-source strong motion records considering fling-step effects includes the following steps: introducing a permanent displacement as a conditional parameter into ground motion selection based on generalized conditional intensity measures, and giving a target permanent displacement by extended probabilistic fault displacement hazard analysis; characterizing a frequency content component of a ground motion with a spectral displacement instead of spectral acceleration in a target ground motion intensity measure set; further calculating an empirical correlation coefficient suitable for near-source strong motion records with permanent displacement, constructing a corresponding target conditional distribution, and finally obtaining a data set of near-source strong motion records with permanent displacement most consistent with a target conditional distribution by optimizing selection from a near-source strong motion database. A reasonable ground motion selection method is provided for seismic response analysis of near-source engineering structures under a strong motion-fault dislocation coupled effect.

### CROSS-REFERENCE TO RELATED APPLICATIONS

This application claims priority to Chinese Patent Application No. 202510050704.8 with a filing date of Jan. 13, 2025. The content of the aforementioned application, including any intervening amendments thereto, is incorporated herein by reference.

### TECHNICAL FIELD

The present disclosure relates to the technical field of seismic records, and in particular, to a method and system for selecting near-source strong motion records considering fling-step effects.

### BACKGROUND

Numerous earthquake disasters show that the stick-slip dislocations of active faults may extend to the surface to produce significant permanent tectonic displacement, which in turn causes serious damage to engineering structures. The surface fault dislocations manifest as the fling-step effect in near-source strong motion records, and may cause unidirectional velocity pulses in the fault slip direction. Meanwhile, the displacement waveform exhibits an approximate step function with a permanent displacement (i.e., fling-step amplitude). Therefore, near-source strong motion records with permanent displacement are of important value for studying the process of strong earthquake fault rupture and coseismic surface deformation.

At present, the studies on the near-source strong motion records with permanent displacement as input load of seismic response analysis are mainly focused on the following: 1. From the perspective of data processing of strong motion records, the fling-step amplitudes (i.e., permanent displacements) corresponding to ground motion records are adjusted based on a baseline correction method for target permanent displacements. The influence of different fault dislocation levels on the seismic response of a fault-crossing structure can be discussed using a series of ground motions with permanent displacement processed by above baseline correction method as input loads. 2. Ground motion simulation methods may be subdivided into: (I) artificial near-source ground motion with permanent displacement is synthesized by superposing the fling-step pulse model with the high-frequency component of strong-motion record; and (II) hybrid broadband ground motion simulation methods directly reflect the fling-step effect in the simulation results of low-frequency displacement waveforms. However, there is still no ground motion selection method considering the fling-step amplitude has been proposed.

The ground motion selection method is centered on “spectrum matching” and involves target spectra, such as the design spectrum, uniform hazard spectrum and conditional mean spectrum. However, it is difficult to fully describe the potential destructive capacity of ground motions with a single ground motion intensity measure. Therefore, the ground motion selection method depending solely on matched spectra has certain restriction. Through a standard ground motion data processing flow (baseline correction combined with band-pass filtering), it is difficult to retain permanent displacement information. Excessive manual interventions involved in a determination criterion for split time points in early multi-segment baseline correction methods may cause errors in recovery results of permanent displacements. In addition, high-pass filtering will filter out low-frequency noise from acceleration records, also remove the low-frequency information corresponding to permanent displacements.

### SUMMARY OF PRESENT INVENTION

An objective of the present disclosure is to provide a method and system for selecting near-source strong motion records considering fling-step effects. Other ground motion features (e.g., duration and cumulative energy) are also taken into account in seismic response analysis. Under a theoretical framework of generalized conditional intensity measures, ground motion selection is achieved by matching of a multivariate conditional distribution constructed for any target ground motion intensity measure set.

Embodiments of the present disclosure provide a method for selecting near-source strong motion records considering fling-step effects, including the following steps:
S1, based on basic information of a target fault and a site, giving a target permanent displacement value corresponding to a specified exceedance probability level by extended probabilistic fault displacement hazard analysis, and in combination with a mean and standard deviation of permanent displacement given by a fling-step effect ground motion prediction model in a specific earthquake rupture scenario, determining a standard deviation coefficient corresponding to a permanent displacement as a conditional parameter;
S2, in the specific earthquake rupture scenario, selecting a ground motion prediction model suitable for near-source strong motion records with permanent displacement to determine an unconditional mean and an unconditional standard deviation corresponding to each ground motion intensity measure in a target ground motion intensity measure set;
S3, based on a database of near-source strong motion records with permanent displacement, calculating a standard deviation correlation coefficient matrix between various ground motion intensity measures suitable for near-source strong ground motions with permanent displacement;
S4, based on a basic concept of generalized conditional intensity measures, calculating a conditional mean and a conditional standard deviation of each ground motion intensity measure, and further constructing a multivariate conditional distribution of the generalized ground motion intensity measures;
S5, randomly extracting a plurality of target simulation vectors from a target multivariate conditional distribution by Latin hypercube sampling, and searching for an alternative ground motion data set having a minimum error with each target simulation vector in the database near-source strong motion records with permanent displacement one by one;
S6, measuring a deviation between each alternative sample distribution and a target conditional distribution by means of an R-value obtained by weighted summation of a statistic D-value in Kolmogorov-Smirnov (K-S) test, and finally taking an alternative data set with a minimum R-value as a final selection result.

Further, the basic information of the target fault and the site in S1 may include a fault type, a fault length, a fault dip, a minimum magnitude of engineering significance, a potential maximum earthquake magnitude, an annual average earthquake occurrence rate, a b-value in Gutenberg-Richter relationship, and an average shear-wave velocity in the top 30 m of the site; the specific earthquake rupture scenario may include a set magnitude, a depth-to-top of rupture, and a closest distance from the site to the rupture plane; and a standard deviation coefficient E_{lnPD} corresponding to the conditional parameter permanent displacement (PD) may be defined as follows:

$${ε}_{ln PD} = \frac{ln PD - {μ}_{ln PD \vert Rup}}{{σ}_{ln PD \vert Rup}}$$

where in the specific earthquake rupture scenario Rup, a mean μ_{lnPD} and a standard deviation σ_{lnPD} of the PD may be given by a corresponding ground motion prediction model, while lnPD is the target value at the specified exceedance probability level and given by the extended probabilistic fault displacement hazard analysis in S1.

Further, the calculation of a correlation coefficient between any two ground motion intensity measures IMᵢ and IMⱼ in S3 may be replaced with the calculation of a correlation coefficient between standard deviation coefficients ε_{lnIM i} and ε_{lnIMj}, with the standard deviation coefficients and the correlation coefficient being defined as follows:

$$ε ln {IM}_{i} = \frac{ln {IM}_{i} - {μ}_{{lnIM}_{i}} ( {rup}_{i} )}{{σ}_{{lnIM}_{i}}} , εln {IM}_{j} = \frac{ln {IM}_{j} - {μ}_{{lnIM}_{j}} ( {rup}_{i} )}{{σ}_{{lnIM}_{j}}}$$

$${ρ}_{ε {lnIM}_{i} , ε {lnIM}_{j}} = \frac{{\sum }_{k = 1}^{n} ( ε ln {IM}_{i} - \overline{εln {IM}_{i}} ) ( ε ln {IM}_{j} - \overline{εln {IM}_{j}} )}{\sqrt{{\sum }_{k = 1}^{n} {( ε ln {IM}_{i} - \overline{εln {IM}_{i}} )}^{2} {\sum }_{k = 1}^{n} {( ε ln {IM}_{j} - \overline{εln {IM}_{j}} )}^{2}}}$$

where actual rupture scenario information corresponding to each strong motion record in the database of near-source strong motion records with permanent displacement is denoted as rupᵢ; a predicted mean and a predicted standard deviation for each ground motion intensity measure IMᵢ given by a selected ground motion prediction model are denoted as μ_{llnIMi|(rupi)} and σ_{lnIMi}, respectively, and the standard deviation coefficient ε_{lnIM i} is determined in combination with an actual value lnIMᵢ (a geometric mean of two horizontal components); n represents a total number of strong motion records contained in the database of near-source strong motion records with permanent displacement; and ε̅l̅n̅I̅M̅ᵢ̅ ε̅l̅n̅I̅M̅ⱼ̅ represent sample means corresponding to the standard deviation coefficients ε_{lnIM i} and ε_{lnIMj}, respectively.

Further, the conditional mean and the conditional standard deviation of each ground motion intensity measure in S4 may be defined as follows:

$${μ}_{{lnIM}_{i} \vert R u p , P D} = {μ}_{{lnIM}_{i} \vert R u p} + {σ}_{{lnIM}_{i} \vert R u p} {ρ}_{{lnIM}_{i} , lnPD \vert Rup} {ε}_{lnPD}$$

$${σ}_{{lnIM}_{i} \vert R u p , P D} = {σ}_{{lnIM}_{i} \vert R u p} \sqrt{1 - {ρ}_{{lnIM}_{i} , lnPD \vert R u p}^{2}}$$

where the mean μ_{lnIMi} and standard deviation σ_{lnImi} in the specific earthquake rupture scenario are given by a ground motion prediction model corresponding to each ground motion intensity measure; and ρ_{lnIMi,lnPD|Rup} represents the correlation coefficient for lnIMᵢ and lnPD.

Further, in S5, since dimensions of parameters in the target ground motion intensity measure set IM are not exactly the same, an error function may be constructed in a form of a weighted sum of squares for errors corresponding to the parameters after standard deviation normalization processing, and expressed as follows:

$${r}^{m , nsim} = {\sum }_{i = 1}^{{N}_{{IM}_{i}}} {{w}_{i} [ \frac{ln {IM}_{i}^{nsim} - ln {IM}_{i}^{m , scaled}}{{σ}_{{lnIM}_{i} \vert Ru {p}^{nsim} , PD}} ]}^{2}$$

where N_{Imi} represents a number of the parameters in the target ground motion intensity measure set IM; lnIMᵢ^{nism} and lnIMᵢ^{m,scaled} represent a nsim-th target simulation vector {IMᵢ} and an m-th amplitude-scaled record {IMᵢ} in the database of near-source strong motion records with permanent displacement, respectively; and wᵢ represents an error weight coefficient endowed for each ground motion intensity measure and is differentially adjusted according to a different importance degree of the ground motion intensity measure.

Further, the R-value obtained by weighted summation of the statistic D-value in the K-S test in S6 may be defined as:

$${D}_{{IM}_{i}} = max \vert {F}_{{IM}_{i} \vert PD} ( i {m}_{i} \vert p d ) - E C D F ( i {m}_{i} ) \vert$$

$$R = {\sum }_{i = 1}^{{N}_{{IM}_{i}}} {{w}_{i} ( {D}_{{IM}_{i}} )}^{2}$$

where F_{IMi|PD}(imᵢ|pd) represents a target generalized conditional intensity measure (GCIM) distribution; ECDF(imᵢ) represents an empirical cumulative distribution function corresponding to an i-th ground motion intensity measure in an alternative ground motion data set; wi is consistent with the weight coefficient of error function or reassigned a value; and finally, an alternative ground motion data set with the minimum R-value is output as an optimal result that meets the target conditional distribution.

A system for selecting near-source strong motion records considering fling-step effects is constructed based on the above near-source strong motion selection method as above described. This system includes a calculation module that is configured to perform the method for selecting near-source strong motion records considering fling-step effects.

The present disclosure has the following beneficial effects: the present disclosure uses permanent displacement, which characterizes the degree of fault displacement, as a conditional parameter to construct a target conditional distribution It is realized that the sample distribution of the selected data set of near-source strong motion records with permanent displacement matches the target conditional distribution well. Furthermore, the present disclosure considers the influence of permanent displacement (i.e., fling-step amplitude) on the low-frequency components of a ground motion. A correlation coefficient matrix more suitable for near-source strong motion records with permanent displacement is calculated. Thus, when the ground motion record selected by this method is used as an input load, the reliability of seismic response of a near-source engineering structure under a strong motion-fault dislocation coupled effect is guaranteed.

### BRIEF DESCRIPTION OF THE DRAWINGS

FIG. 1 is a flowchart showing a method for selecting near-source strong motion records considering fling-step effects;

FIG. 2 is a schematic diagram illustrating a corresponding permanent displacement hazard curve, target permanent displacement of an engineering site and magnitude of the specific earthquake rupture scenario given by probabilistic fault displacement hazard analysis in an embodiment;

FIG. 3 illustrates a heat map of correlation between 18 ground motion intensity measures suitable for near-source strong motion records with permanent displacement, and a correlation coefficient map of spectral displacements from 0.01 to 10 periods;

FIG. 4 is a comparison diagram showing the differences between the selected ground motion record data set with the target conditional distribution;

FIG. 5 is a comparison diagram showing a target conditional distribution corresponding to ground motion intensity measures, an acceptance domain of K-S test (with a confidence level of 0.1), and a sample cumulative distribution of a selected ground motion data set.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by a person of ordinary skill in the art on the basis of the embodiments of the present disclosure without creative efforts shall fall within the protection scope of the present disclosure.

The present disclosure is described in detail below with reference to specific embodiments.

### Embodiment 1

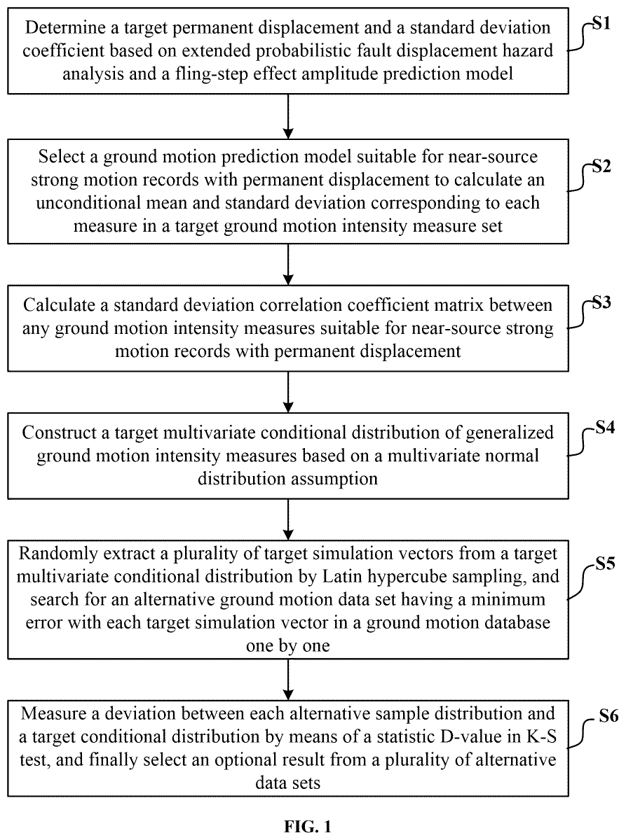

As shown in FIG. 1, a method for selecting near-source strong motion records considering fling-step effects includes the following steps.

In step S1, based on basic information of a target fault and a site, a target permanent displacement value corresponding to a specified exceedance probability level is given by extended probabilistic fault displacement hazard analysis, and in combination with a mean and standard deviation of permanent displacement given by a fling-step effect ground motion prediction model in a specific earthquake rupture scenario, a standard deviation coefficient corresponding to a permanent displacement as a conditional parameter is determined. The basic information of the target fault and the site includes a fault type, a fault length, a fault dip, a minimum magnitude of engineering significance, a potential maximum earthquake magnitude, an annual average earthquake occurrence rate, a b-value in Gutenberg-Richter relationship, and an average shear-wave velocity in the top 30 m of the site. The specific earthquake rupture scenario includes a set magnitude, a depth-to-top of rupture, and a closest distance from the site to the rupture plane. A standard deviation coefficient ε_{lnPD} corresponding to the conditional parameter PD is defined as follows:

$${ε}_{lnPD} = \frac{ln P D - {μ}_{lnPD \vert R u p}}{{σ}_{lnPD \vert R u p}}$$

In the specific earthquake rupture scenario Rup, a mean μ_{lnPD} and a standard deviation σ_{lnPD} of the PD may be given by a corresponding ground motion prediction model, while lnPD is the target value at the specified exceedance probability level and given by the extended probabilistic fault displacement hazard analysis in S1.

In step S2, in the specific earthquake rupture scenario, a ground motion prediction model suitable for near-source strong motion records with permanent displacement is selected to determine an unconditional mean and an unconditional standard deviation corresponding to each ground motion intensity measure in a target ground motion intensity measure set. The ground motion intensity measures involved in the target ground motion intensity measure set may be flexibly combined according to a specific requirement, and include but are not limited to: peak ground acceleration, peak ground velocity, peak ground displacement, permanent displacement, Arias intensity, cumulative absolute velocity, significant duration, spectral intensity, and spectral displacement.

In step S3, based on a database of near-source strong motion records with permanent displacement, a standard deviation correlation coefficient matrix between various ground motion intensity measures suitable for near-source strong ground motions with permanent displacement is calculated. The calculation of a correlation coefficient between any two ground motion intensity measures IMᵢ and IMⱼ may be replaced with the calculation of a correlation coefficient between standard deviation coefficients ε_{lnIM i} and ε_{lnIMj}, with the standard deviation coefficients and the correlation coefficient being defined as follows:

$$ε ln {IM}_{i} = \frac{ln {IM}_{i} - {μ}_{{lnIM}_{i}} ( {rup}_{i} )}{{σ}_{{lnIM}_{i}}} , εln {IM}_{j} = \frac{ln {IM}_{j} - {μ}_{{lnIM}_{j}} ( {rup}_{i} )}{{σ}_{{lnIM}_{j}}}$$

$${ρ}_{ε {lnIM}_{i} , ε {lnIM}_{j}} = \frac{{\sum }_{k = 1}^{n} ( ε ln {IM}_{i} - \overline{εln {IM}_{i}} ) ( ε ln {IM}_{j} - \overline{εln {IM}_{j}} )}{\sqrt{{\sum }_{k = 1}^{n} {( ε ln {IM}_{i} - \overline{εln {IM}_{i}} )}^{2} {\sum }_{k = 1}^{n} {( ε ln {IM}_{j} - \overline{εln {IM}_{j}} )}^{2}}}$$

where actual rupture scenario information corresponding to each strong motion record in the database of near-source strong motion records with permanent displacement is denoted as rupᵢ; the predicted mean and predicted standard deviation for each ground motion intensity measure IMᵢ given by a selected ground motion prediction model are denoted as μ_{lnIMi|(rupi)} and σ_{lnIMi}, respectively, and the standard deviation coefficient ε_{lnIM i} is determined in combination with an actual value lnIMᵢ (a geometric mean of two horizontal components); n represents a total number of strong motion records contained in the database of near-source strong motion records with permanent displacement; and ε̅l̅n̅I̅M̅ᵢ̅ ε̅l̅n̅I̅M̅ⱼ̅ represent sample means corresponding to the standard deviation coefficients ε_{lnMi} and ε_{lnIMj}, respectively.

In step S4, based on a basic concept of generalized conditional intensity measures, a conditional mean and a conditional standard deviation of each ground motion intensity measure are calculated, and a multivariate conditional distribution of the generalized ground motion intensity measures is further constructed. The conditional mean and the conditional standard deviation of each ground motion intensity measure are defined as follows:

$${μ}_{{lnIM}_{i} \vert R u p , P D} = {μ}_{{lnIM}_{i} \vert R u p} + {σ}_{{lnIM}_{i} \vert R u p} {ρ}_{{lnIM}_{i} , lnPD \vert Rup} {ε}_{lnPD}$$

$${σ}_{{lnIM}_{i} \vert R u p , P D} = {σ}_{{lnIM}_{i} \vert R u p} \sqrt{1 - {ρ}_{{lnIM}_{i} , lnPD \vert R u p}^{2}}$$

where a mean μ_{lnIM i} and a standard deviation σ_{lnIMi} in the specific earthquake rupture scenario Rup are given by a ground motion prediction model corresponding to each ground motion intensity measure; and ρ_{lnIMi,lnPD|Rup} represents the correlation coefficient for lnIMᵢ and lnPD. They can be obtained in step S3.

In step S5, a plurality of target simulation vectors is approximatively and randomly extracted from a target multivariate conditional distribution by Latin hypercube sampling, and an alternative ground motion data set having a minimum error with each target simulation vector is searched for in the database of near-source strong motion records with permanent displacement one by one. Since dimensions of parameters in the target ground motion intensity measure set IM are not exactly the same, an error function is constructed in a form of a weighted sum of squares for errors corresponding to the parameters after standard deviation normalization processing, and expressed as follows:

$${r}^{m , nsim} = {\sum }_{i = 1}^{{N}_{{IM}_{i}}} {{w}_{i} [ \frac{ln {IM}_{i}^{nsim} - ln {IM}_{i}^{m , scaled}}{{σ}_{{lnIM}_{i} \vert Ru {p}^{nsim} , PD}} ]}^{2}$$

where N_{IMi} represents a number of the parameters in the target ground motion intensity measure set IM; lnIMᵢ^{nism} and lnIMᵢ^{m,scaled} represent a nsim-th target simulation vector {IMᵢ} and an m-th amplitude-modulated record {IMᵢ} in the database of near-source strong motion records with permanent displacement, respectively; and wi represents an error weight coefficient endowed for each ground motion intensity measure and is differentially adjusted according to a different importance degree of the ground motion intensity measure.

In step S6, a deviation between each alternative sample distribution and the target conditional distribution is measured by means of an R-value obtained by weighted summation of a statistic D-value in K-S test, and finally an alternative ground motion data set with a minimum R-value is taken as a final selection result. The R-value obtained by weighted summation of the statistic D-value in the K-S test is defined as:

$${D}_{{IM}_{i}} = max \vert {F}_{{IM}_{i} \vert PD} ( i {m}_{i} \vert p d ) - E C D F ( i {m}_{i} ) \vert$$

$$R = {\sum }_{i = 1}^{{N}_{{IM}_{i}}} {{w}_{i} ( {D}_{{IM}_{i}} )}^{2}$$

where F_{IMi|PD}(imᵢ|pd) represents a target generalized conditional intensity measure (GCIM) distribution; ECDF (imᵢ) represents an empirical cumulative distribution function corresponding to an i-th ground motion intensity measure in an alternative ground motion data set; wi is consistent with the weight coefficient of error function or reassigned a value; and finally, an alternative ground motion data set with the minimum R-value is output as an optimal result that meets the target conditional distribution.

### Embodiment 2

On the basis of Embodiment 1, the present embodiment utilizes a system for selecting near-source strong motion records considering fling-step effects, including a calculation module configured to perform the method for selecting near-source strong motion records considering fling-step effects. The method is applied to a near-source engineering site, and includes the following specific steps.

(1) A target permanent displacement value and a corresponding standard deviation coefficient are determined.

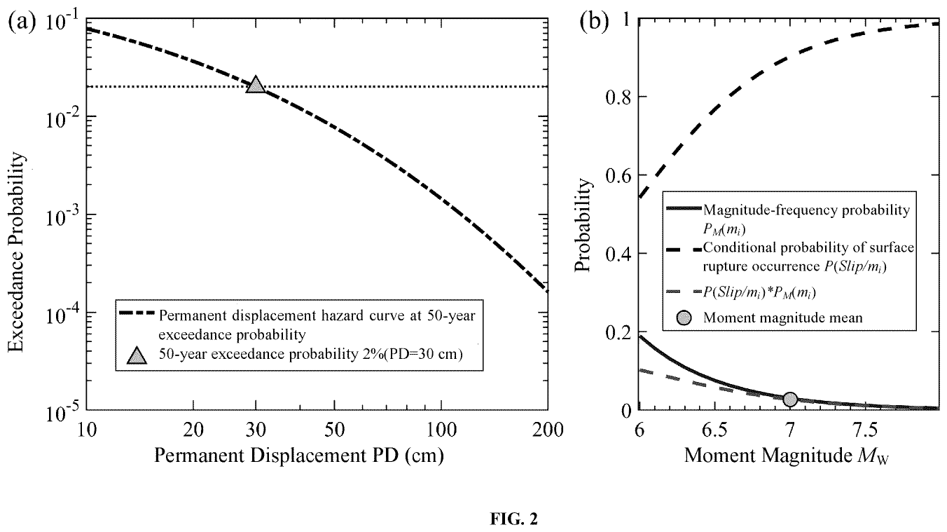

It is assumed that the basic information of the target fault and the engineering site are listed in Table 1. The permanent displacement (PD=30 cm) at the 50-years exceedance probability level of 2% determined by probabilistic fault displacement hazard analysis is used as the conditional parameter, and a moment magnitude (Mw=7) corresponding to the specific earthquake rupture scenario is given, as shown in FIG. 2. In addition to the permanent displacement PD, the target ground motion intensity measure set further includes peak ground acceleration PGA, peak ground velocity PGV, peak ground displacement PGD, permanent displacement Sd (with a period of 0.05 s to 10 s), 5-95% significant duration D₈₅₋₉₅, spectral intensity SI, and cumulative absolute velocity CAV.

The number of selected ground motion records in the present embodiment is set to 30, which may also be adjusted according to an actual requirement.

TABLE 1
Basic information of the target fault and the engineering site

| Parameter | Value | Parameter | Value | |
|---|---|---|---|---|
| Fault type | Strike-slip | b-value in Gutenberg-Richter | 0.8 | |
| | | relationship | | |
| Fault length, LF | 100 km | Annual average earthquake | 0.006 | |
| | | occurrence rate, α | | |
| Fault dip, dip | 90° | Average shear-wave velocity in | 360 | m/s |
| | | the top 30 m of the site, V_{S30} | | |
| Tectonic environment | Interplate | Moment magnitude in the | 7 | |
| | | specific earthquake rupture | | |
| | | scenario, Mw | | |
| Minimum magnitude of | 6 | closest distance from the site to | 10 | km |
| engineering significance | | the rupture plane, Rup | | |
| Potential maximum | 8 | Depth-to-top of rupture, Ztor | 0 | km |

earthquake magnitude

(2) An unconditional mean and standard deviation corresponding to each ground motion intensity measure in a target ground motion intensity measure set are determined.

In the specific earthquake rupture scenario, the unconditional mean and the unconditional standard deviation corresponding to each ground motion intensity measure determined by the selected ground motion prediction model suitable for near-source strong motion records with permanent displacement are listed in Table 2.

TABLE 2
Unconditional mean and the unconditional standard deviation

| Ground | | Unconditional | Ground | | Unconditional |
|---|---|---|---|---|---|
| Motion | Unconditional | Logarithmic | Motion | Unconditional | Logarithmic |
| Intensity | Logarithmic | Standard | Intensity | Logarithmic | Standard |
| Measure IM | Mean μ_{lgIM} | Deviation σ_{lgIM} | Measure IM | Mean μ_{lgIM} | Deviation σ_{lgIM} |
| PGA | 2.6012 | 0.2745 | Sd(T = 0.05 s) | −1.6540 | 0.3630 |
| PGV | 1.6294 | 0.2579 | Sd(T = 0.10 s) | −0.8909 | 0.3759 |
| PGD | 1.5898 | 0.3388 | Sd(T = 0.20 s) | −0.1917 | 0.3642 |
| PD | 1.1612 | 0.3600 | Sd(T = 0.30 s) | 0.1560 | 0.3564 |
| D_{S5-95} | 1.1354 | 0.1730 | Sd(T = 0.50 s) | 0.5092 | 0.3694 |
| SI | 2.1651 | 0.2815 | Sd(T = 1.0 s) | 0.8766 | 0.3756 |
| CAV | 3.1082 | 0.2012 | Sd(T = 2.0 s) | 1.1822 | 0.3680 |
| | | | Sd(T = 3.0 s) | 1.3471 | 0.3649 |
| | | | Sd(T = 5.0 s) | 1.5584 | 0.3588 |
| | | | Sd(T = 10.0 s) | 1.5898 | 0.3388 |

(3) A standard deviation correlation coefficient matrix between ground motion intensity measures suitable for near-source strong motion records with permanent displacement is calculated.

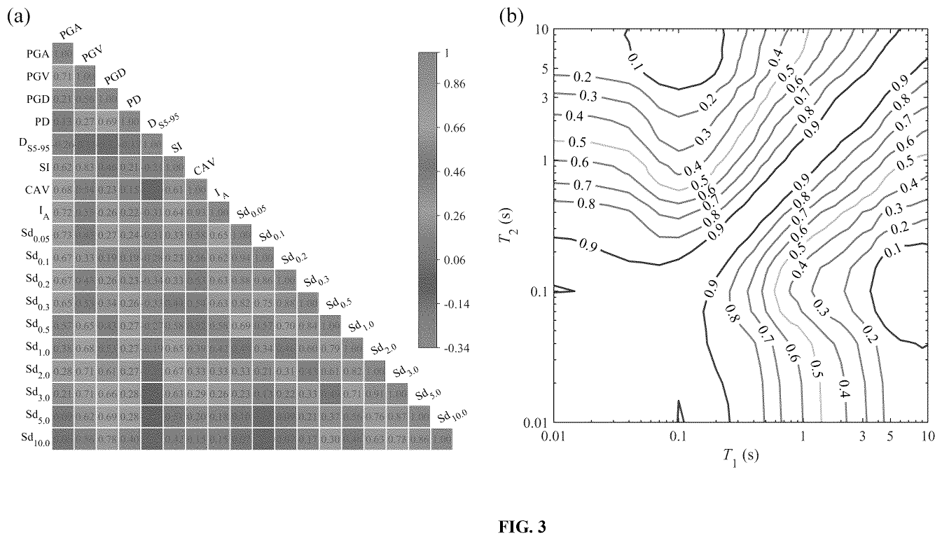

Based on a ground motion database composed of 597 near-source strong motion records with permanent displacement of 65 earthquake events, in combination with the ground motion prediction model, the standard deviation correlation coefficient matrix between various ground motion intensity measures suitable for near-source strong motion records with permanent displacement is calculated, as shown in FIG. 3. The correlation between PD and PGD is the highest, and the correlation coefficient ρ reaches 0.69. In contrast, the correlations between other ground motion intensity measures and PD are relatively low.

(4) A conditional mean and a conditional standard deviation of each ground motion intensity measure are calculated.

In combination with the above three steps, provided that the target permanent displacement PD is 30 cm and the standard deviation coefficient ε_{lnPD} is 0.878, calculation formulas for the conditional mean and the conditional standard deviation of any ground motion intensity measure are as follows:

$${μ}_{{lnIM}_{i} \vert R u p , P D} = {μ}_{{lnIM}_{i} \vert R u p} + {σ}_{{lnIM}_{i} \vert R u p} {ρ}_{{lnIM}_{i} , lnPD \vert Rup} {ε}_{lnPD}$$

$${σ}_{{lnIM}_{i} \vert R u p , P D} = {σ}_{{lnIM}_{i} \vert R u p} \sqrt{1 - {ρ}_{{lnIM}_{i} , lnPD \vert R u p}^{2}}$$

where the mean μ_{lnIM i} and standard deviation σ_{lnIMi} in the specific earthquake rupture scenario Rup are given by a ground motion prediction model corresponding to each ground motion intensity measure; and ρ_{lnIMi,lnPD|Rup} represents the correlation coefficient for lnIMᵢ and lnPD. Final calculation results of conditional mean and standard deviation are listed in Table 3.

TABLE 3
Final calculation results of conditional mean and standard deviation

| Ground | | Conditional | Ground | | Conditional |
|---|---|---|---|---|---|
| Motion | Conditional | Logarithmic | Motion | Conditional | Logarithmic |
| Intensity | Logarithmic | Standard | Intensity | Logarithmic | Standard |
| Measure IM | Mean μ_{lgIM} | Deviation σ_{lgIM} | Measure IM | Mean μ_{lgIM} | Deviation σ_{lgIM} |
| PGA | 2.6322 | 0.2722 | Sd(T = 0.05 s) | −1.5780 | 0.3526 |
| PGV | 1.6898 | 0.2486 | Sd(T = 0.10 s) | −0.8285 | 0.3691 |
| PGD | 1.7937 | 0.2465 | Sd(T = 0.20 s) | −0.1166 | 0.3540 |
| PD | 1.4771 | 0 | Sd(T = 0.30 s) | 0.2379 | 0.3439 |
| D_{S5-95} | 1.1089 | 0.1703 | Sd(T = 0.50 s) | 0.5976 | 0.3554 |
| SI | 2.2158 | 0.2755 | Sd(T = 1.0 s) | 0.9642 | 0.3621 |
| CAV | 3.1391 | 0.1981 | Sd(T = 2.0 s) | 1.2707 | 0.3539 |
| | | | Sd(T = 3.0 s) | 1.4371 | 0.3501 |
| | | | Sd(T = 5.0 s) | 1.6450 | 0.3450 |
| | | | Sd(T = 10.0 s) | 1.7084 | 0.3106 |

(5) An alternative ground motion data set having a minimum error with each target simulation vector is searched for one by one.

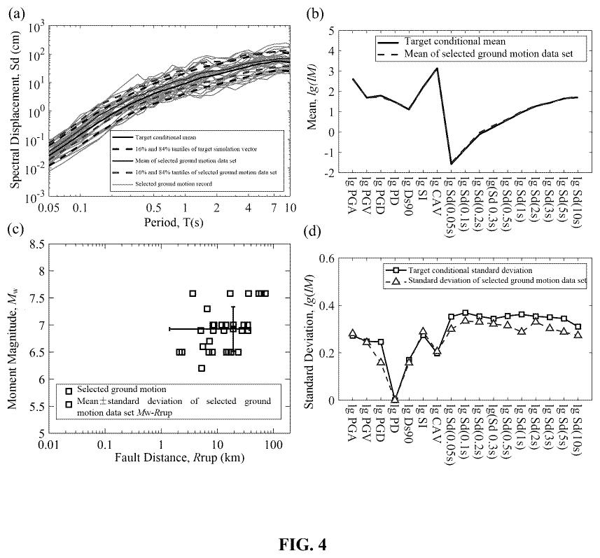

In the present embodiment, 50 target simulation vectors are extracted by Latin hypercube sampling, and an error weight vector endowed for the target ground motion intensity measure set IM is wᵢ={0.1,0.1,0.1,0,0.1,0.1,0.1,0.4}. The weight coefficient of 0.4 for the spectral displacement is averagely distributed to 10 selected control periods. Optimal selection results in a plurality of alternative ground motion data sets are as shown in FIG. 4.

(6) An optimal ground motion data set is selected from the plurality of alternative ground motion data sets by the K-S test.

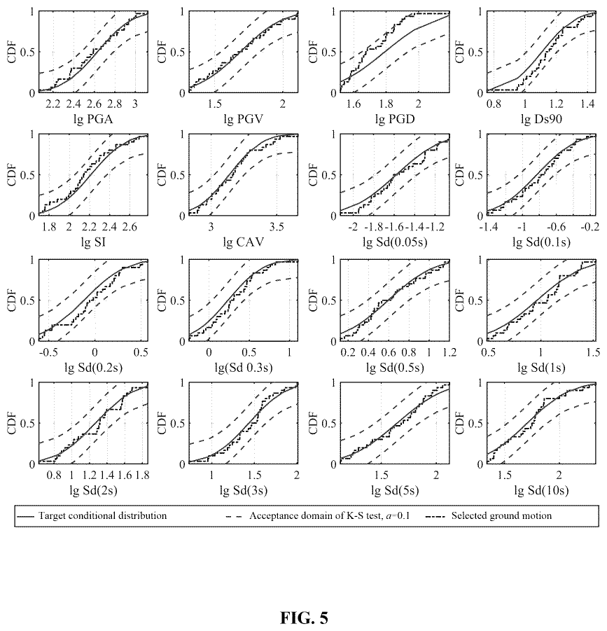

A deviation between each alternative sample distribution and the target conditional distribution is measured by means of an R-value obtained by weighted summation of a statistic D-value in K-S test. A confidence interval is set to 0.1. The sample cumulative distribution corresponding to the finally selected optimal ground motion data set and the acceptance domain of the K-S test are as shown in FIG. 5. The cumulative distributions of the ground motion intensity measures achieve good matching with corresponding conditional distributions.

The inventive method for selecting near-source strong motion records considering fling-step effects still follows a ground motion selection framework based on the generalized conditional intensity measures as a whole, with the following differences: 1. Due to the fact that the damage of near-source engineering (especially fault-crossing engineering) comes from coupling of strong motion and fault dislocation, and the large tectonic deformation caused by active fault dislocation is undoubtedly a greater threat to the engineering structure. The spectral acceleration at the first-mode period of the target structure, which is typically regarded as the conditional intensity measure, is replaced by the permanent displacement. 2. Although the spectral acceleration and the spectral displacement are both commonly used in ground motion selection for seismic response analysis and seismic performance evaluation, in consideration of higher influence degree of the fling-step amplitude on the long-period amplitude of the spectral displacement. The spectral displacement is used instead of spectral acceleration to characterize the frequency content characteristics of the ground motions in the target ground motion intensity measure set, which provides service for displacement-based seismic design.

It is apparent for those skilled in the art that the present disclosure is not limited to details of the above exemplary embodiments, and that the present disclosure may be implemented in other specific forms without departing from spirit or basic features of the present disclosure. Accordingly, the embodiments should be regarded in all points of view as exemplary and not restrictive, and the scope of the present disclosure is defined by the appended claims rather than the above description. Therefore, all changes falling within the meaning and scope of equivalent elements of the claims should be included in the present disclosure. The reference numerals in the claims should not be considered as limiting the involved claims.

What is claimed is:

1. A method for selecting near-source strong motion records considering fling-step effects, comprising the following steps:
S1, based on basic information of a target fault and a site, giving a target permanent displacement value corresponding to a specified exceedance probability level by extended probabilistic fault displacement hazard analysis, and in combination with a mean and standard deviation of permanent displacement given by a fling-step effect ground motion prediction model in a specific earthquake rupture scenario, determining a standard deviation coefficient corresponding to a permanent displacement as a conditional parameter;
S2, in the specific earthquake rupture scenario, selecting a ground motion prediction model suitable for near-source strong motion records with permanent displacement to determine an unconditional mean and an unconditional standard deviation corresponding to each ground motion intensity measure in a target ground motion intensity measure set;
S3, based on a database of near-source strong motion records with permanent displacement, calculating a standard deviation correlation coefficient matrix between various ground motion intensity measures suitable for near-source strong ground motion records with permanent displacement;
S4, based on a basic concept of generalized conditional intensity measures, calculating a conditional mean and a conditional standard deviation of each ground motion intensity measure, and further constructing a multivariate conditional distribution of the generalized ground motion intensity measures;
S5, randomly extracting a plurality of target simulation vectors from a target multivariate conditional distribution by Latin hypercube sampling, and searching for an alternative ground motion data set having a minimum error with each target simulation vector in the database of near-source strong motion records with permanent displacement one by one;
S6, measuring a deviation between each alternative sample distribution and a target conditional distribution by means of an R-value obtained by weighted summation of a statistic D-value in Kolmogorov-Smirnov (K-S) test, and finally taking an alternative data set with a minimum R-value as a final selection result.

2. The method according to claim 1, wherein the basic information of the target fault and the site in S1 comprises a fault type, a fault length, a fault dip, a minimum magnitude of engineering significance, a potential maximum earthquake magnitude, an annual average earthquake occurrence rate, a b-value in Gutenberg-Richter relationship, and an average shear-wave velocity in the top 30 m of the site; the specific earthquake rupture scenario comprises a set magnitude, a depth-to-top of rupture, and a closest distance from the site to the rupture plane; and a standard deviation coefficient ε_{lnPD} corresponding to the conditional parameter PD is defined as follows:
$${ε}_{lnPD} = \frac{ln P D - {μ}_{lnPD \vert R u p}}{{σ}_{lnPD \vert R u p}}$$
wherein in the specific earthquake rupture scenario Rup, a mean μ_{lnPD} and a standard deviation σ_{lnPD} of the PD are given by a corresponding ground motion prediction model, while lnPD is the target value at the specified exceedance probability level and given by the extended probabilistic fault displacement hazard analysis in S1.

3. The method according to claim 1, wherein the calculation of a correlation coefficient between any two ground motion intensity measures IMᵢ and IMⱼ in S3 is replaced with the calculation of a correlation coefficient between standard deviation coefficients ε_{lnIM i} and ε_{lnIMj}, with the standard deviation coefficients and the correlation coefficient being defined as follows:
$$ε ln {IM}_{i} = \frac{ln {IM}_{i} - {μ}_{{lnIM}_{i}} ( {rup}_{i} )}{{σ}_{{lnIM}_{i}}} , εln {IM}_{j} = \frac{ln {IM}_{j} - {μ}_{{lnIM}_{j}} ( {rup}_{i} )}{{σ}_{{lnIM}_{j}}}$$
$${ρ}_{ε {lnIM}_{i} , ε {lnIM}_{j}} = \frac{{\sum }_{k = 1}^{n} ( ε ln {IM}_{i} - \overline{εln {IM}_{i}} ) ( ε ln {IM}_{j} - \overline{εln {IM}_{j}} )}{\sqrt{{\sum }_{k = 1}^{n} {( ε ln {IM}_{i} - \overline{εln {IM}_{i}} )}^{2} {\sum }_{k = 1}^{n} {( ε ln {IM}_{j} - \overline{εln {IM}_{j}} )}^{2}}}$$
wherein actual rupture scenario information corresponding to each strong motion record in the database of near-source strong motion records with permanent displacement is denoted as rupᵢ; a predicted mean and a predicted standard deviation for each ground motion intensity measure IMᵢ given by a selected ground motion prediction model are denoted as μ_{lnIMi|(rupi)} and σ_{lnIMi}, respectively, and the standard deviation coefficient ε_{lnIM i} is determined in combination with an actual value lnIMᵢ (a geometric mean of two horizontal components); n represents a total number of strong motion records contained in the database of near-source strong motion records with permanent displacement; and ε̅l̅n̅I̅M̅ᵢ̅ ε̅l̅n̅I̅M̅ⱼ̅ represent sample means corresponding to the standard deviation coefficients ε_{lnMi} and ε_{lnIMj}, respectively.

4. The method according to claim 1, wherein the conditional mean and the conditional standard deviation of each ground motion intensity measure in S4 are defined as follows:
$${μ}_{{lnIM}_{i} \vert R u p , P D} = {μ}_{{lnIM}_{i} \vert R u p} + {σ}_{{lnIM}_{i} \vert R u p} {ρ}_{{lnIM}_{i} , lnPD \vert Rup} {ε}_{lnPD}$$
$${σ}_{{lnIM}_{i} \vert R u p , P D} = {σ}_{{lnIM}_{i} \vert R u p} \sqrt{1 - {ρ}_{{lnIM}_{i} , lnPD \vert R u p}^{2}}$$
wherein the mean μₗₙₘᵢ and standard deviation σ_{lnIMi} in the specific earthquake rupture scenario Rup are given by a ground motion prediction model corresponding to each ground motion intensity measure; and ρ_{lnIMi,lnPD|Rup} represents the correlation coefficient for lnIMᵢ and lnPD.

5. The method for selecting the near-source strong motion records considering the fling-step effect according to claim 1, wherein in S5, since dimensions of parameters in the target ground motion intensity measure set IM are not exactly the same, an error function is constructed in a form of a weighted sum of squares for errors corresponding to the parameters after standard deviation normalization processing, and expressed as follows:
$${r}^{m , nsim} = {\sum }_{i = 1}^{{N}_{{IM}_{i}}} {{w}_{i} [ \frac{ln {IM}_{i}^{nsim} - ln {IM}_{i}^{m , scaled}}{{σ}_{{lnIM}_{i} \vert Ru {p}^{nsim} , PD}} ]}^{2}$$
wherein N_{Imi} represents a number of the parameters in the target ground motion intensity measure set IM; lnIMᵢ^{nism} and lnIMᵢ^{m,scaled} represent a nsim-th target simulation vector {IMᵢ} and an m-th amplitude-scaled record {IMᵢ} in the database of near-source strong motion records with permanent displacement, respectively; and wᵢ represents an error weight coefficient endowed for each ground motion intensity measure and is differentially adjusted according to a different importance degree of the ground motion intensity measure.

6. The method for selecting the near-source strong motion records considering fling-step effects according to claim 1, wherein the R-value obtained by weighted summation of the statistic D-value in the K-S test in S6 is defined as:
$${D}_{{IM}_{i}} = max \vert {F}_{{IM}_{i} \vert PD} ( i {m}_{i} \vert p d ) - E C D F ( i {m}_{i} ) \vert$$
$$R = {\sum }_{i = 1}^{{N}_{{IM}_{i}}} {{w}_{i} ( {D}_{{IM}_{i}} )}^{2}$$
wherein F_{IMi|PD}(imᵢ|pd) represents a target generalized conditional intensity measure (GCIM) distribution; ECDF (imᵢ) represents an empirical cumulative distribution function corresponding to an i-th ground motion intensity measure in an alternative ground motion data set; wi is consistent with the weight coefficient of the error function or reassigned a value; and finally, an alternative ground motion data set with the minimum R-value is output as an optimal result that meets the target conditional distribution.

7. A system for selecting near-source strong motion records considering fling-step effects, comprising: a calculation module configured to perform the method according to claim 1.
